(19) United States
(12) Patent Application Publication
(10) Pub. No.: US 2025/0371151 A1
(43) Pub. Date: Dec. 4, 2025

(54) AUTOMATED COMPREHENSIVE SECURITY SCANNING SYSTEM FOR LARGE-SCALE DISTRIBUTED CODE REPOSITORIES

(71) Applicant: DISNEY ENTERPRISES, INC., Burbank, CA (US)

(72) Inventors: Karishma Mahesh PATEL, Seattle, WA (US); Vishaal R. EKHALIKAR, Franklin Lakes, NJ (US); Bryan M. MORRISON, Broadlands, VA (US); Richard REA, Ontario, CA (US)

(21) Appl. No.: 18/825,987

(22) Filed: Sep. 5, 2024

Related U.S. Application Data
(60) Provisional application No. 63/655,460, filed on Jun. 3, 2024.

(51) Int. Cl. G06F 21/56; G06F 16/27

(52) U.S. Cl. CPC G06F 21/563; G06F 16/27; G06F 2221/033

(57) ABSTRACT

The present invention sets forth a technique for performing automated software security scanning. The method includes copying a plurality of codebase branches included in a code repository into a clone database, based on one or more scripts included in a script database. The method also includes simultaneously executing one or more scanning operations on each of the plurality of codebase branches via a plurality of processing threads and generating one or more scan results based on the one or more scanning operations executed on the plurality of codebase branches.

### CROSS-REFERENCE TO RELATED APPLICATIONS

This application claims priority benefit to the U.S. provisional application titled “AUTOMATED COMPREHENSIVE SECURITY SCANNING SYSTEM FOR LARGE-SCALE DISTRIBUTED CODE REPOSITORIES,” filed on Jun. 3, 2024, and having Ser. No. 63/655,460. This related application is also hereby incorporated by reference in its entirety.

### BACKGROUND

### Field of the Various Embodiments

Embodiments of the present disclosure relate generally to computer security and, more specifically, to automated techniques for performing automated software security scanning on large-scale distributed code repositories.

### DESCRIPTION OF THE RELATED ART

Software security scanning is a critical task for many organizations and is necessary to assess security vulnerabilities in a software codebase. Software security scanning may also identify open-source software licensing issues in a codebase, as well as detect organizational secrets or other sensitive information that may be improperly stored in a software codebase. An organization may maintain multiple software codebases stored within one or more source code management (SCM) systems or code repositories. Further, each codebase within an SCM may include multiple branches of software code, such as a development branch or a production branch.

Existing techniques for performing automated software security scanning are typically limited to scanning software codebases individually, or in small batches of tens or dozens of software codebases. Consequently, these techniques do not scale to very large collections of software codebases and are not computationally performant to automatically scan tens or hundreds of thousands of software codebases in an acceptable period of time. For example, scanning tens of thousands of software codebases individually or in small batches via existing techniques may require years, if not decades, to complete.

Existing automated software security scanning techniques may also require customization or configuration for each vendor-specific SCM system used by an organization. Consequently, these existing techniques may be limited to scanning software codebases included in a single SCM or code repository, and may require substantial re-configuration for each additional SCM or code repository included in an organization's computing system. Further, existing automated software security scanning techniques may be limited to scanning a single codebase branch of a software codebase within an SCM, potentially leading to an incomplete analysis of an organization's codebases.

As the foregoing illustrates, what is needed in the art are more effective techniques for automated software security scanning on large-scale distributed code repositories.

### SUMMARY

In one embodiment of the present invention, a computer-implemented method for performing automated software security scanning comprises copying, via execution of one or more scripts included in a script database, a plurality of codebase branches included in a code repository into a clone database and launching a plurality of container tasks for simultaneously executing one or more scanning operations on codebase branches included in the plurality of codebase branches. The method further comprises generating one or more scan results based on the one or more scanning operations executed on the plurality of codebase branches.

One technical advantage of the disclosed techniques relative to the prior art is that the disclosed techniques allow for efficient, centralized, large-scale automated scanning of multiple software codebases, where each software codebase may include multiple codebase branches. The disclosed techniques may also scan a codebase branch without needing to first compile software code included in the codebase branch, decreasing scanning time requirements compared to prior art techniques. Further, the disclosed techniques may simultaneously or sequentially scan some or all codebase branches of software codebases located within multiple disparate source code management systems to ensure a complete analysis of an organization's codebases. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the scanning engine of FIG. 1, according to some embodiments.

FIG. 3 is a flow diagram of method steps for performing automated software security scanning, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

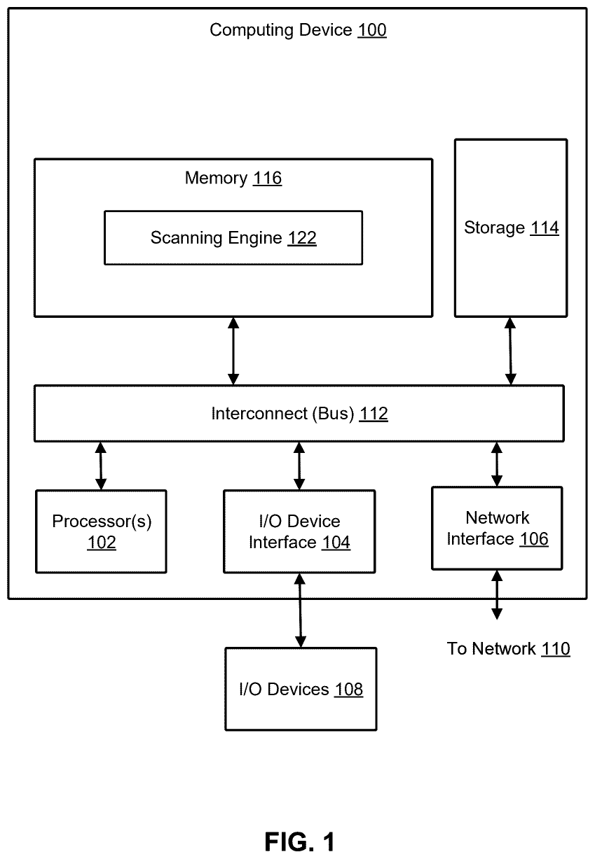

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a scanning engine 122 that resides in a memory 116.

It is noted that the computing device described herein is illustrative and that any other technically feasible configurations fall within the scope of the present disclosure. For example, multiple instances of scanning engine 122 could execute on a set of nodes in a distributed and/or cloud computing system to implement the functionality of computing device 100. In another example, scanning engine 122 could execute on various sets of hardware, types of devices, or environments to adapt scanning engine 122 to different use cases or applications. In a third example, scanning engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Scanning engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including scanning engine 122.

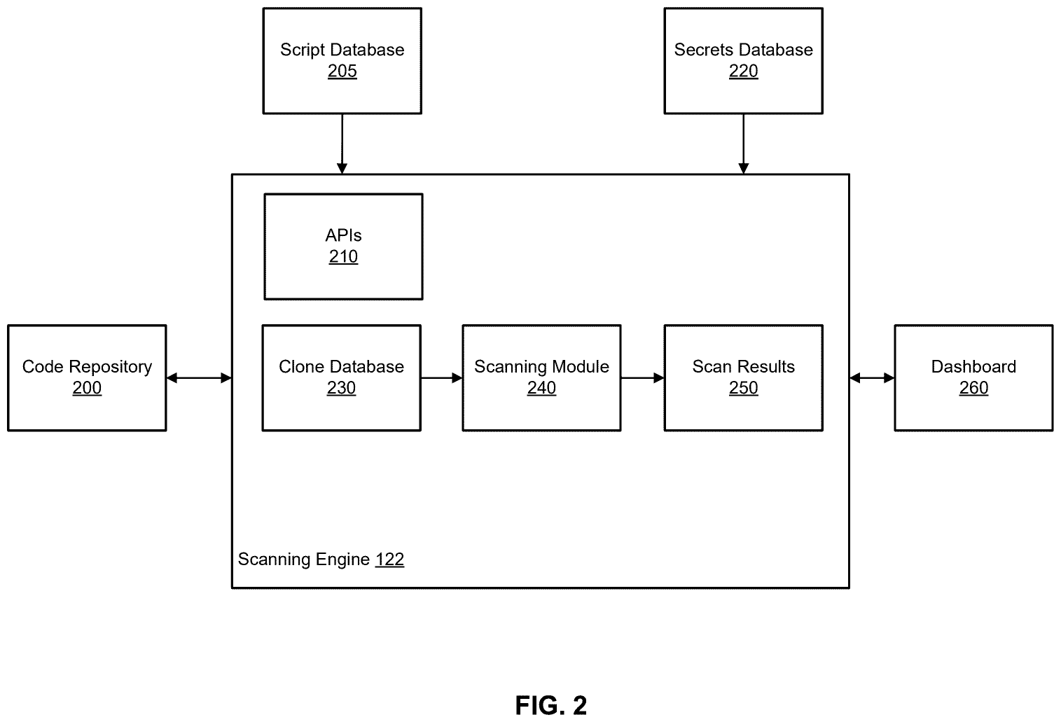

FIG. 2 is a more detailed illustration of scanning engine 122 of FIG. 1, according to some embodiments. Based on one or more scripts included in script database 205 and permission/authentication information included in secrets database 220, scanning engine 122 analyzes one or more codebase branches included in code repository 200 and generates scan results for display via a dashboard 260. Scanning engine 122 includes, without limitation, APIs 210, clone database 230, scanning module 240, and scan results 250.

Code repository 200 may include one or more source code management systems (SCMs). Each SCM included in code repository 200 may include multiple software codebases associated with one or more software projects. Each software codebase may further include one or more codebase branches, where the one or more codebase branches may include, e.g., a master branch, a development branch, a staging branch, or a production branch. Each codebase branch may represent a different development stage and/or version of a software project. In various embodiments, each the one or more SCMs included in code repository 200 may be stored locally within an organization's enterprise computing environment, or may be stored remotely, e.g., in a cloud storage facility. Each SCM may be developed and maintained locally or may be provided by a third-party vendor.

Script database 205 includes one or more scripts configured to instruct scanning engine 122 to traverse one or more SCMs included in code repository 200 and identify one or more codebase branches included in the one or more SCMs. Script database 205 may include one or more scripts configured to instruct scanning engine 122 to traverse a hierarchical structure of codebase branches included in the one or more SCMs. For example, the one or more scripts may be configured to instruct scanning engine 122 to identify one or more parent or top-level codebase branches, as well as to identify lower-level nested codebase branches associated with the parent or top-level codebase branches. In various embodiments, script database 205 may additionally or alternatively specify a set of software codebases and/or codebase branches included in code repository 200 for retrieval and analysis. In these embodiments, the specified set of software codebases and/or codebase branches may include software codebases and/or codebase branches included in a priority database (not shown). The priority database may include entries associating one or more software codebases and/or codebase branches with one or more priority levels, e.g., “low,” “medium,” “high,” or “critical.”

In a further embodiment, script database 205 may include a script instructing scanning engine 122 to traverse all or a portion of code repository 200, identify one or more software codebases and/or codebase branches included in code repository 200, and compare the identified software codebases and/or codebase branches to entries included in the priority database. A script included in script database 205 may instruct scanning engine 122 to retrieve and analyze a subset of software codebases and/or codebase branches based on one or more priority levels associated with the software codebases and/or codebase branches.

Secrets database 220 includes identification, authorization, and/or permissions data associated with an organization's enterprise computing environment. In various embodiments, secrets database 220 may include username and password data, user/group membership data, per-user or per-group permissions data, authentication tokens, or permissions tokens. Scanning engine 122 may retrieve identification, authorization, and/or permissions data included in secrets database as necessary to access one or more SCMs included in code repository 200, either directly or via one or more of application program interfaces (APIs) discussed below.

APIs 210 include one or more programmatic interfaces between scanning engine 122 and code repository 200. In various embodiments, APIs 210 may include multiple interfaces, where each interface is associated with one or more SCMs included in code repository 200. Scanning engine 122 may, via APIs 210, access one or more SCMs included in code repository 200, identify one or more codebases included in each of the one or more SCMs, and/or retrieve one or more codebase branches included in the one or more codebases. As discussed above, scanning engine 122 may retrieve identification, authorization, and/or permissions data from secrets database 220 and transmit the identification, authorization, and/or permissions data to code repository 200 via APIs 210. For each codebase branch included in code repository 200, APIs 210 may retrieve a uniform resource locator (URL) or other location identifier associated with the codebase branch.

Based on one or more scripts included in script database 205 and URLs or other location information retrieved by APIs 210, scanning engine 122 copies one or more codebase branches included in code repository 200 and stores the copied codebase branches in clone database 230. Each codebase branch stored in clone database 230 represents a snapshot of the codebase branch as it existed in code repository 200 at the time of retrieval. In various embodiments, clone database 230 is operable to simultaneously store copies of all codebase branches included in code repository 200. Scanning engine 122 transmits the one or more copied codebase branches to scanning module 240.

Scanning module 240 analyzes copied codebase branches received from clone database 230 and detects one or more conditions, such as security vulnerabilities, third-party dependency and/or licensing issues, or the inadvertent inclusion of secret or otherwise sensitive data. In various embodiments, scanning module 240 may include one or more scanning applications, where each scanning application is operable to detect one or more of the above conditions. Scanning module 240 may analyze the copied codebase branches without needing to first compile software code included in the copied codebase branches, reducing the time required to analyze the copied codebase branches.

In some embodiments, scanning module 240 may compare all or a portion of software code included in a copied codebase branch to a database of known security vulnerabilities. Scanning module 240 may also identify software code included in the copied codebase branch that accidentally or maliciously bypasses authorization routines, such as via the inclusion of a hardcoded authorization or permission token in the software code.

Scanning module 240 may also analyze third-party software code included in a copied codebase branch. For example, scanning module 240 may identify third-party software errors, such as outdated software or missing or outdated dependencies or libraries. Scanning module 240 may also identify missing or expired licenses associated with third-party software code.

Scanning module 240 may further identify secret, personal or other sensitive data included in a copied codebase branch. Sensitive data may include secret/proprietary organizational information, usernames, passwords, personally identifiable information (PII), security tokens, or authorization tokens. Scanning module 240 may compare a copied codebase branch to an organizational database of sensitive data. Scanning module 240 may also include a machine learning model that has been previously trained to identify sensitive data included in software code.

Scanning module 240 may scan multiple copied codebase branches simultaneously. In various embodiments, scanning engine 122 may include multiple instances of scanning module 240, where each instance of scanning module 240 analyzes a different copied codebase branch. Additionally or alternatively, a single instance of scanning module 240 may also analyze multiple copied codebase branches simultaneously via multithreading techniques. For example, scanning engine 122 may launch a plurality of processing threads, and scanning module 240 may analyze multiple copied codebase branches associated with a single codebase included in a single SCM by assigning each copied codebase branch to a different processing thread. As another example, scanning module 240 may analyze multiple copied codebase branches associated with multiple codebases included in one or more SCMs by assigning each copied codebase branch to a different processing thread. Scanning module 240 may aggregate analysis results generated by the different processing threads to generate analysis results associated with the single codebase.

In various embodiments, scanning engine 122 may launch a plurality of container tasks, where each container task includes software code necessary to analyze one or more copied codebase branches, as well as any libraries, dependencies, or other files required to execute the software code. Scanning engine 122 may query one or more SCMs via API calls and determine a quantity of copied codebase branches to be analyzed. In various embodiments, scanning engine 122 may launch a separate container task for each copied codebase branch. In other embodiments, scanning engine 122 may divide analysis tasks among multiple container tasks by launching multiple container tasks and assigning multiple copied codebase branches to each container task included in the multiple container tasks. For each launched container task, scanning engine 122 associates an SCM name with the container task, along with a quantity of codebase branches copied from the SCM into clone database 230. Scanning module 240 may aggregate analysis results generated by the multiple container tasks to generate analysis results associated with one or more codebase branches included in a single codebase.

In various embodiments, scanning engine 122 may maintain a queue of one or more codebase branches included in clone database 230. Scanning engine 122 may assign one of the one or more codebase branches to a single instance of scanning module 240 for analysis. Scanning engine 122 may assign a codebase branch to a single processing thread included in the single instance of scanning module 240 or to a container task as discussed above. Scanning engine 122 may assign a codebase branch based on the position of the codebase branch within the queue, i.e., first-in/first-out (FIFO) or last-in/first-out (LIFO). Alternatively or additionally, scanning engine 122 may assign a codebase branch based on characteristics of the codebase branch, such as a size, a creation date, a modification date, or an assigned priority associated with the codebase branch.

In various embodiments, scanning module 240 may generate and transmit a report to scanning engine 122 that the analysis of a particular copied codebase branch is complete. Scanning engine 122 may delete the copied codebase branch from clone database 230 based on the report, reducing necessary computing resource requirements. Scanning engine 122 may also record the progress of scanning module 240 based on reports received from scanning module 240. Scanning module 240 generates and transmits scan results 250 associated with a copied codebase branch to scanning engine 122.

Scan results 250 may include one or more entries associated with each copied codebase branch analyzed by scanning module 240. For each copied codebase branch, an associated entry may indicate that scanning module 240 identified no security vulnerabilities, third-party software issues, or sensitive organizational information in the copied codebase branch. If scanning module 240 identified one or more security vulnerabilities, third-party software issues, or sensitive organizational information, an associated entry in scan results 250 may include the type, quantity, and/or location(s) of issues identified in the copied codebase branch.

Scanning engine 122 may analyze, aggregate, and/or reformat entries included in scan results 250. For example, scanning engine 122 may aggregate all entries included in scan results 250 that are associated with all copied codebase branches for a particular codebase, and generate an entry in scan results 250 that includes aggregated results associated with the codebase. In various embodiments, scanning engine 122 may also generate aggregated entries in scan results 250 associated with a particular SCM. Scanning engine 122 may also generate statistical data associated with code repository 200, such as a total quantity of SCMs/codebases/codebase branches analyzed, quantities and types of vulnerabilities or other issues identified in code repository 200, or metrics quantifying the time spent analyzing one or more SCMs, codebases, or codebase branches. Scanning engine 122 may store the generated statistical data as one or more entries in scan results 250. Scanning engine 122 transmits scan results 250 to dashboard 260.

Dashboard 260 includes one or more textual and/or graphical elements presented to a user via, e.g., a screen or other display device. For example, dashboard 260 may include a listing of one or more SCMs, codebases, and/or codebase branches included in code repository 200 and scan results 250 associated with the one or more SCMs, codebases, and/or codebase branches. In various embodiments, a user may interact with scanning engine 122 via dashboard 260, e.g., by selecting a particular SCM, codebase, or codebase branch listed in dashboard 260 and querying scanning engine 122 for all entries included in scan results 250 associated with the particular SCM, codebase, or codebase branch. In various embodiments, the user may designate one or more codebases or codebase branches for manual or automatic remediation of vulnerabilities or other issues identified in scan results 250.

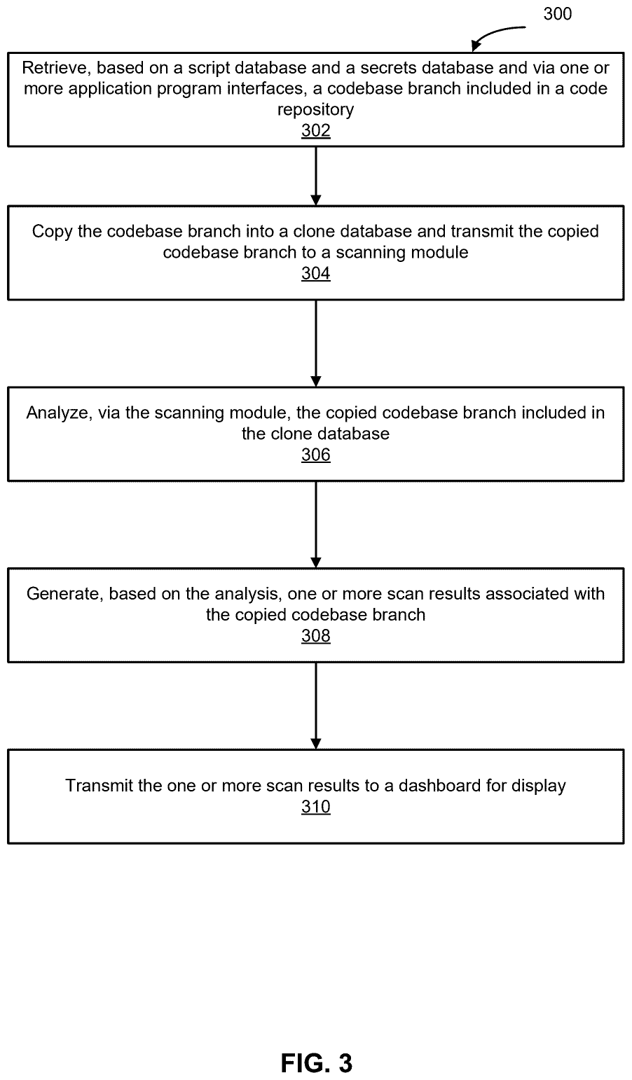

FIG. 3 is a flow diagram of method steps for performing automated software security scanning, according to some embodiments. Although the method steps are described in conjunction with the systems of FIGS. 1 and 2, persons skilled in the art will understand that any system configured to perform the method steps in any order falls within the scope of the present disclosure.

As shown, in step 302 of method 300, scanning engine 122 retrieves a codebase branch included in code repository 200. Scanning engine 122 retrieves the codebase branch based on one or more scripts included in script database 205. Scanning engine 122 may retrieve the codebase branch via one or more of application program interfaces (APIs) 210. Scanning engine 122 may retrieve one or more items of identification, authentication, and/or permission information from secrets database 220, as required by the one or more of APIs 210.

In step 304, scanning engine 122 copies the codebase branch into clone database 230 and transmits the copied codebase branch to scanning module 240. In various embodiments, scanning engine 122 may repeat steps 302 and 304 to copy additional codebase branches from code repository 200 into clone database 230 and transmit the additional codebase branches to scanning module 240. Scanning engine 122 may copy and transmit all or a subset of multiple codebase branches included in code repository 200. In various embodiments, scanning engine 122 may execute steps 302 and/or 304 simultaneously on multiple codebase branches via multithreading or any other suitable parallel processing technique.

In step 306, scanning engine 122 analyzes the copied codebase branch included in clone database 230 via scanning module 240. Scanning module 240 identifies one or more of security vulnerabilities, third-party software issues, or secret or otherwise sensitive information in the copied codebase branch. In various embodiments, scanning engine 122 may perform step 306 on multiple copied codebase branches simultaneously via a multithreading technique, where each processing thread included in scanning module 240 analyzes a different one of the multiple copied codebase branches. In other embodiments, scanning engine 122 may perform step 306 on multiple copied codebase branches simultaneously by assigning one or more copied codebase branches to a plurality of container tasks executing in parallel. Each different processing thread or container task includes a distinct naming convention, such that each codebase branch may be uniquely identified during retrieval, copying, or scanning while avoiding naming duplication or collisions.

By executing one or more of steps 302, 304, or 306 in parallel via multiple processing threads and/or multiple container tasks, the disclosed techniques enable the analysis of a large number of codebase branches without a significant increase in the time required to analyze any particular single codebase branch.

In step 308, scanning engine 122 generates one or more scan results 250 associated with the copied codebase branch. Scan results 250 may include an entry indicating that scanning module 240 identified no security vulnerabilities, third-party software issues, or sensitive organizational information in the copied codebase branch. If scanning module 240 identified one or more security vulnerabilities, third-party software issues, or sensitive organizational information, an associated entry in scan results 250 may include the type, quantity, and/or location(s) of identified issues identified in the copied codebase branch. In various embodiments, scanning engine 122 may perform step 308 simultaneously on multiple copied codebase branches, where each of multiple processing threads included in scanning module 240 generates scan results 250 associated with a different one of the multiple copied codebase branches. In other embodiments, scanning engine 122 may perform step 308 simultaneously on multiple copied codebase branches, where each of multiple container tasks launched by scanning engine 122 generates scan results 250 associated with a different one of the multiple copied codebase branches

In step 310, scanning engine 122 transmits scan results 250 to dashboard 260 for display to a user. Dashboard 260 includes one or more textual and/or graphical elements presented to a user via, e.g., a screen or other display device. For example, dashboard 260 may include a listing of one or more SCMs, codebases, and/or codebase branches included in code repository 200 and scan results 250 associated with the one or more SCMs, codebases, and/or codebase branches. In various embodiments, a user may interact with scanning engine 122 via dashboard 260, e.g., by selecting a particular SCM, codebase, or codebase branch listed in dashboard 260 and querying scanning engine 122 for all entries included in scan results 250 associated with the particular SCM, codebase, or codebase branch. In various embodiments, the user may designate one or more codebases or codebase branches for manual or automatic remediation of vulnerabilities or other issues identified in scan results 250.

In sum, the disclosed techniques perform automated software security scanning on software codebases that are maintained in one or more source code management (SCM) systems or code repositories. In various embodiments, the automated software security scanning may include analyzing a codebase and detecting one or more of security vulnerabilities, third-party dependency and/or licensing issues, or the inadvertent inclusion of secret or otherwise sensitive data in the codebase. The disclosed techniques may execute in series or parallel to sequentially or simultaneously analyze multiple codebases included in one or more SCMs or code repositories.

In operation, a scanning engine retrieves one or more codebase branches included in a codebase from a code repository. A code repository may include one of multiple SCMs, where each SCM may be locally developed or provided by a third-party vendor. A codebase branch of a codebase may include, e.g., a master branch, a development branch, a staging branch, or a production branch. The scanning engine provides a single centralized system for scanning all or part of a potentially decentralized code repository that may include multiple SCMs residing in geographically separated computing systems. The centralized nature of the scanning engine also provides transparency of asset inventory, as the scanning engine is aware of the identities and locations of all codebase branches included in an enterprise computing environment.

The scanning engine may access a script database, a secrets database, and one or more application program interfaces (APIs). The script database includes necessary instructions enabling the scanning engine to identify a code repository, identify one or more codebase branches included in the code repository, and specify one or more scanning operations to be performed on the identified codebase branches. The secrets database includes authentication and/or permission information necessary for the scanning engine to access the code repositories and retrieve codebases. The secrets database may include username and password data, user/group membership data, per-user or per-group permissions data, authentication tokens, or permissions tokens. The APIs provide programmatic interfaces between the scanning engine and each of the multiple code repositories.

The scanning engine copies the retrieved codebase branches into a clone database. The clone database includes a snapshot of each retrieved codebase branch, where the snapshot represents the status and contents of the codebase branch at the time that the scanning engine retrieved the codebase branch. The clone database may include copies of multiple codebase branches retrieved from multiple code repositories.

The scanning engine analyzes the copies of the retrieved codebase branches via a scanning module. The scanning module analyzes a codebase branch and detects one or more of security vulnerabilities, third-party dependency and/or licensing issues, or the inadvertent inclusion of secret or otherwise sensitive data in the codebase branch. Based on instructions included in the script database, the scanning module may perform all or a subset of the above analyses on a granular, per-branch basis. The scanning module is operable to perform the above analyses on a codebase branch without first compiling computer code included in the codebase branch. Analysis without prior code compilation requires less time compared to techniques that require code compilation before analysis. In various embodiments, the disclosed techniques may include multiple instances of the scanning module, where the multiple instances of the scanning module simultaneously analyze multiple codebase branches in parallel. In other embodiments, a single instance of the scanning module may simultaneously analyze multiple codebase branches in parallel via multithreading techniques or multiple container tasks.

The scanning engine generates scan results based on the analyses of the one or more codebase branches. The scan results may include an identification of the analyzed codebase branch and indications of one or more detected security vulnerabilities, dependency/licensing issues, or inadvertent inclusions of secret or sensitive information. The scan results may also include an indication that the scanning engine detected no vulnerabilities or other issues in the analyzed codebase branch. The scan results may further include statistical data associated with an analyzed codebase branch, such as the size of the codebase branch, an analysis start time, an analysis end time, or an analysis duration. The scanning engine transmits the scan results to a dashboard for display to a user, enabling comprehensive vulnerability and/or security scanning and reporting, even in large-scale enterprise computing environments.

One technical advantage of the disclosed techniques relative to the prior art is that the disclosed techniques allow for efficient, centralized, large-scale automated scanning of multiple software codebases, where each software codebase may include multiple codebase branches. The disclosed techniques may also scan a codebase branch without needing to first compile software code included in the codebase branch, decreasing scanning time requirements compared to prior art techniques. Further, the disclosed techniques may simultaneously or sequentially scan some or all codebase branches of software codebases located within multiple disparate source code management systems to ensure a complete analysis of an organization's codebases. These technical advantages provide one or more technological improvements over prior art approaches.
1. In some embodiments, a computer-implemented method for performing automated software security scanning comprises copying, via execution of one or more scripts included in a script database, a plurality of codebase branches included in a code repository into a clone database, launching a plurality of container tasks for simultaneously executing one or more scanning operations on codebase branches included in the plurality of codebase branches, and generating one or more scan results based on the one or more scanning operations executed on the plurality of codebase branches.
2. The computer-implemented method of clause 1, wherein copying the plurality of codebase branches further comprises copying one or more additional codebase branches included in one or more additional code repositories into the clone database.
3. The computer-implemented method of clauses 1 or 2, wherein the one or more scan results include one or more of indications of software vulnerabilities associated with one of the plurality of codebase branches, third-party software dependency errors associated with one of the plurality of codebase branches, or secret/sensitive organizational data included in one of the plurality of codebase branches.
4. The computer-implemented method of any of clauses 1-3, wherein the one or more scripts specify a subset of codebase branches included in the code repository.
5. The computer-implemented method of any of clauses 1-4, wherein the specifying of the subset of codebase branches is based on one or more priority levels associated with the plurality of codebase branches.
6. The computer-implemented method of any of clauses 1-5, further comprising identifying, based on the one or more scripts, one or more top-level codebase branches and one or more nested codebase branches associated with the one or more top-level codebase branches.
7. The computer-implemented method of any of clauses 1-6, wherein copying the plurality of codebase branches is based on one or more of authentication, identification, or permission information included in a secrets database.
8. The computer-implemented method of any of clauses 1-7, further comprising displaying the one or more scan results via an interactive dashboard, wherein the one or more scan results include statistical data associated with the plurality of codebase branches.
9. The computer-implemented method of any of clauses 1-8, further comprising assigning one of the plurality of codebase branches to one of the plurality of container tasks based on a queue of codebase branches.
10. The computer-implemented method of any of clauses 1-9, further comprising removing one or more of the plurality of copied codebase branches from the clone database after execution of the one or more scanning operations.
11. In some embodiments, one or more non-transitory computer-readable media store instructions that, when executed by one or more processors, cause the one or more processors to perform the steps of copying, via execution of one or more scripts included in a script database, a plurality of codebase branches included in a code repository into a clone database, launching a plurality of container tasks for simultaneously executing one or more scanning operations on codebase branches included in the plurality of codebase branches, and generating one or more scan results based on the one or more scanning operations executed on the plurality of codebase branches.
12. The one or more non-transitory computer-readable media of clause 11, wherein copying the plurality of codebase branches further comprises copying one or more additional codebase branches included in one or more additional code repositories into the clone database.
13. The one or more non-transitory computer-readable media of clauses 11 or 12, wherein the one or more scan results include one or more of indications of software vulnerabilities associated with one of the plurality of codebase branches, third-party software dependency errors associated with one of the plurality of codebase branches, or secret/sensitive organizational data included in one of the plurality of codebase branches.
14. The one or more non-transitory computer-readable media of any of clauses 11-13, wherein the one or more scripts specify a subset of codebase branches included in the code repository.
15. The one or more non-transitory computer-readable media of any of clauses 11-14, wherein the specifying of the subset of codebase branches is based on one or more priority levels associated with the plurality of codebase branches.
16. The one or more non-transitory computer-readable media of any of clauses 11-15, further comprising identifying, based on the one or more scripts, one or more top-level codebase branches and one or more nested codebase branches associated with the one or more top-level codebase branches.
17. The one or more non-transitory computer-readable media of any of clauses 11-16, wherein copying the plurality of codebase branches is based on one or more of authentication, identification, or permission information included in a secrets database.
18. In some embodiments, a system comprises one or more memories for storing instructions, and one or more processors for executing the instructions to copy, via execution of one or more scripts included in a script database, a plurality of codebase branches included in a code repository into a clone database, launch a plurality of container tasks for simultaneously executing one or more scanning operations on codebase branches included in the plurality of codebase branches, and generating one or more scan results based on the one or more scanning operations executed on the plurality of codebase branches.
19. The system of clause 18, wherein copying the plurality of codebase branches further comprises copying one or more additional codebase branches included in one or more additional code repositories into the clone database.
20. The system of clauses 18 or 19, wherein the one or more scan results include one or more of indications of software vulnerabilities associated with one of the plurality of codebase branches, third-party software dependency errors associated with one of the plurality of codebase branches, or secret/sensitive organizational data included in one of the plurality of codebase branches.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing automated software security scanning, the method comprising:
copying, via execution of one or more scripts included in a script database, a plurality of codebase branches included in a code repository into a clone database;
launching a plurality of container tasks for simultaneously executing one or more scanning operations on codebase branches included in the plurality of codebase branches; and
generating one or more scan results based on the one or more scanning operations executed on the plurality of codebase branches.

2. The computer-implemented method of claim 1, wherein copying the plurality of codebase branches further comprises copying one or more additional codebase branches included in one or more additional code repositories into the clone database.

3. The computer-implemented method of claim 1, wherein the one or more scan results include one or more of indications of software vulnerabilities associated with one of the plurality of codebase branches, third-party software dependency errors associated with one of the plurality of codebase branches, or secret/sensitive organizational data included in one of the plurality of codebase branches.

4. The computer-implemented method of claim 1, wherein the one or more scripts specify a subset of codebase branches included in the code repository.

5. The computer-implemented method of claim 4, wherein the specifying of the subset of codebase branches is based on one or more priority levels associated with the plurality of codebase branches.

6. The computer-implemented method of claim 1, further comprising identifying, based on the one or more scripts, one or more top-level codebase branches and one or more nested codebase branches associated with the one or more top-level codebase branches.

7. The computer-implemented method of claim 1, wherein copying the plurality of codebase branches is based on one or more of authentication, identification, or permission information included in a secrets database.

8. The computer-implemented method of claim 1, further comprising displaying the one or more scan results via an interactive dashboard, wherein the one or more scan results include statistical data associated with the plurality of codebase branches.

9. The computer-implemented method of claim 1, further comprising assigning one of the plurality of codebase branches to one of the plurality of container tasks based on a queue of codebase branches.

10. The computer-implemented method of claim 1, further comprising removing one or more of the plurality of copied codebase branches from the clone database after execution of the one or more scanning operations.

11. One or more non-transitory computer-readable media storing instructions that, when executed by one or more processors, cause the one or more processors to perform the steps of:
copying, via execution of one or more scripts included in a script database, a plurality of codebase branches included in a code repository into a clone database;
launching a plurality of container tasks for simultaneously executing one or more scanning operations on codebase branches included in the plurality of codebase branches; and
generating one or more scan results based on the one or more scanning operations executed on the plurality of codebase branches.

12. The one or more non-transitory computer-readable media of claim 11, wherein copying the plurality of codebase branches further comprises copying one or more additional codebase branches included in one or more additional code repositories into the clone database.

13. The one or more non-transitory computer-readable media of claim 11, wherein the one or more scan results include one or more of indications of software vulnerabilities associated with one of the plurality of codebase branches, third-party software dependency errors associated with one of the plurality of codebase branches, or secret/sensitive organizational data included in one of the plurality of codebase branches.

14. The one or more non-transitory computer-readable media of claim 11, wherein the one or more scripts specify a subset of codebase branches included in the code repository.

15. The one or more non-transitory computer-readable media of claim 14, wherein the specifying of the subset of codebase branches is based on one or more priority levels associated with the plurality of codebase branches.

16. The one or more non-transitory computer-readable media of claim 11, further comprising identifying, based on the one or more scripts, one or more top-level codebase branches and one or more nested codebase branches associated with the one or more top-level codebase branches.

17. The one or more non-transitory computer-readable media of claim 11, wherein copying the plurality of codebase branches is based on one or more of authentication, identification, or permission information included in a secrets database.

18. A system comprising:
one or more memories for storing instructions; and
one or more processors for executing the instructions to:
copy, via execution of one or more scripts included in a script database, a plurality of codebase branches included in a code repository into a clone database;
launch a plurality of container tasks for simultaneously executing one or more scanning operations on codebase branches included in the plurality of codebase branches; and
generating one or more scan results based on the one or more scanning operations executed on the plurality of codebase branches.

19. The system of claim 18, wherein copying the plurality of codebase branches further comprises copying one or more additional codebase branches included in one or more additional code repositories into the clone database.

20. The system of claim 18, wherein the one or more scan results include one or more of indications of software vulnerabilities associated with one of the plurality of codebase branches, third-party software dependency errors associated with one of the plurality of codebase branches, or secret/sensitive organizational data included in one of the plurality of codebase branches.
